(19) United States
(12) Patent Application Publication
(10) Pub. No.: US 2007/0131119 A1
(43) Pub. Date: Jun. 14, 2007

(54) Coffee maker having a filter support incorporating a sieve

(76) Inventors: Hans J. Kodden, Hoogeveen (NL); Rodin E. Bruinsma, Zuidlaren (NL)

Correspondence Address: PHILIPS ELECTRONICS NORTH AMERICA CORPORATION;INTELLECTUAL PROPERTY & STANDARDS, 1109 MCKAY DRIVE, M/S-41SJ, SAN JOSE, CA, 95131, US

(21) Appl. No.: 10/584,487

(22) PCT Filed: Dec. 15, 2004
(86) PCT No.: PCT/IB04/52812

§ 371 Date: Jun. 22, 2006

(30) Foreign Application Priority Data
Dec. 23, 2003 (GB) 0329743.9

(51) Int. Cl. A47J 31/00

(52) U.S. Cl. 99/279

(57) ABSTRACT

A filter support (23) for supporting a filter pad or such like in a coffee maker. The filter support (23) comprises a disc with a discharge opening (31) at its centre. On one surface (32) of the filter support (23) there are a plurality of support projections (33). When a filter pad is placed on the filter support (23), the underside of the filter pad rests on the support projections (33) so that liquid (coffee) flows out of the bottom of the filter pad and over the surface (32). A sieve (34) is provided around the discharge opening (26). In this example, the sieve (34) comprises upstands (35) that are spaced apart to provide apertures (36). The apertures (36) are the same width or narrower than the discharge opening (31) so that they allow liquid (coffee) to pass from the surface (32) to the discharge opening (31), but prevent particles, such as stray coffee grounds, reaching and blocking the discharge opening (31).

This invention relates to a coffee maker having a filter support incorporating a sieve and to such a filter support by itself.

There are a large variety of coffee makers presently in common use, but this invention is primarily relates to coffee makers that use coffee pads, such as the applicants' Senseo® coffee maker. Coffee makers of this type are described in patent publications EP 0904717 and WO 03/055366 for example.

Coffee pads for these pad-type coffee makers typically each comprise a disc shape wad of coffee grounds enclosed in filter paper. To make coffee, a coffee pad is inserted in a brewing chamber of a coffee maker, where it is supported in position by a filter support. More specifically, the underside of the coffee pad is supported such that hot water supplied at pressure to the top of the chamber can pass through the coffee pad to a discharge opening in the bottom of the chamber. As the hot water is pushed through the pad, coffee extract mixes with the hot water to produce coffee. This is similar to the manner in which coffee is made in conventional espresso coffee machines. However, pad-type coffee makers have the advantage of requiring significantly less pressure than conventional espresso coffee makers (around 1 bar over atmospheric pressure rather than 13 to 15 bar) to push hot water through the coffee grounds (in the coffee pad) at the desired rate. This generally makes them cheaper to manufacture than espresso coffee makers.

Another feature of pad-type coffee makers is their foam chamber. Although pad-type coffee makers use relatively low pressure, the discharge opening in the brewing chamber is sufficiently small to cause the brewed coffee to exit the brewing chamber as jet of liquid. This jet enters the foam chamber, from which the coffee is dispensed through a spout into a cup for drinking. As the jet impacts a side of the foam chamber, or the surface of coffee already in the foam chamber, small bubbles are created in the coffee. These bubbles create a layer of foam on the surface of the coffee, which is often referred to as a “crema layer”. This is a desirable quality.

However, the small size of the discharge opening means that it is prone to blocking. Indeed, the discharge opening is of comparable size to typical coffee grounds in the coffee pads. This makes it particularly vulnerable to blockage by stray coffee grounds, which might escape from a coffee pad should the filter paper of the coffee pad tear for example. These blockages are extremely inconvenient, as the coffee maker must be depressurised before the coffee maker can be opened to unblock the discharge opening. In the worst case, it can take a few days for the pressure to dissipate. It is therefore desirable to reduce the likelihood of the discharge opening becoming blocked.

According to one aspect of the present invention, there is provided a coffee maker having a brewing chamber and a filter support for supporting a filter in the brewing chamber at a defined position, the filter support comprising:

a discharge opening for discharging brewed coffee from the brewing chamber; and

a sieve between the defined position and the discharge opening, the sieve having apertures that allow brewed coffee to pass, but that are the same width or narrower than the discharge opening.

In other words, a sieve is provided between the filter and discharge opening. Coffee grounds or particles that might block the discharge opening are stopped by the sieve, as the apertures of the sieve have the same or smaller width than the discharge opening. Whilst any coffee grounds small enough to pass through the apertures should also pass through the discharge opening, larger coffee grounds, that might block the discharge opening, are stopped by the sieve. If any of the apertures themselves become blocked by coffee grounds, brewed coffee can still flow through the other aperture(s) of the sieve to the discharge opening. The coffee maker of the invention is therefore highly resistant to blocking.

Typically, the filter support is removed to change the filter or for cleaning. It is usually therefore a separate component of the coffee maker and the invention can usefully be incorporated in a filter support alone.

According to another aspect of the present invention, there is therefore provided a filter support for supporting a filter in a brewing chamber of a coffee maker at a defined position, the filter support comprising:

a discharge opening for discharging brewed coffee from the brewing chamber; and

a sieve between the defined position and the discharge opening, the sieve having apertures that allow brewed coffee to pass, but that are the same width or narrower than the discharge opening.

In use, brewed coffee passes out of the filter, to the discharge opening. The sieve therefore extends across the path of the brewed coffee upstream of the discharge opening. This allows it to strain the brewed coffee before it is discharged through the discharge opening.

The apertures;of the sieve should be substantially the same width or narrower than the width of the discharge opening. Typically, they are around 0.5 mm across or less. It is preferred that they are substantially 0.5 mm wide. Of course, they may be longer than their defined width, but still be effective in stopping coffee grounds and such like from reaching the discharge opening. Similarly, they might be narrower than their defined width in places. The dimension of the apertures defined by the invention is that, at substantially any point within the aperture, the sides of the aperture are substantially the given width or less apart in at least one direction.

The filter support might be any suitable shape. However, filter pads of most conventional pad-type coffee machines are disc shaped. The filter support is also therefore typically disc shaped. More generally, the filter support may include a surface for directing brewed coffee to the discharge opening. This surface usually extends across a substantially circular area. For example, the surface itself may be circular. Alternatively, the surface may comprise a channel or channels. The channel or channels might substantially cover the circular area. What is important is that, when the surface is arranged under the filter, the surface may be useful for catching brewed coffee exiting the filter. It is therefore arranged to extend under the filter in use. It is also usually substantially flat, although in another example it may slope toward the discharge opening to assist liquid flow.

For the surface to effectively direct brewed coffee to the discharge opening, the filter may be spaced away from it. In other words the filter support may have one or more projections for supporting the filter away from the surface. The defined position of the filter may therefore be defined by the projections. Typically, the support comprises plural projections standing on the surface. For example, the projections may extend to an imaginary surface or plane. This imaginary surface or plane forms a platform for the filter to rest on. In other words, it may define the position of the filter. In one particularly preferred example, the projections are studs. For example, the projections may be domed and approximately as wide as they are high. These studs might be arranged over the surface, for example in a uniform pattern. The filter support may therefore be a stud plate.

The sieve itself can also have a variety of structures. It might comprise a mesh or grille for example. It is useful for the sieve to extend over the surface, e.g. substantially parallel with the surface. To reach the surface, the brewed coffee then must first pass through the sieve. Indeed, the sieve may extend across the whole of the surface or even be the same shape as the surface, e.g. circular. Conveniently, the sieve can rest on the projections in use, for example under the filter.

In another example, the sieve extends across the discharge opening. More specifically, the sieve covers the discharge opening, but not the surface. This means that the sieve can be smaller.

In yet another example, the sieve may comprise an upstand on the surface. This may be a mesh or grille as mentioned above, but it is preferred that the sieve comprises plural upstands, the spaces between which form the apertures. These upstands need not be joined at the ends distal from the surface. Rather, the sieve can be open away from the discharge opening. This structure makes the filter support easy to clean. More importantly, it also allows the filter to be made from a single injection moulded piece. This is desirable in itself and, according to another aspect of the present invention, there is provided a method of manufacturing a filter support according to the invention, the method comprising injection moulding the filter support as a single piece.

Where the sieve comprises an upstand, it is useful for it to extend to the same imaginary surface or plane as the support projections. This means that the sieve can contribute to supporting the filter away from the surface of the filter support.

Similarly, when the sieve comprises an upstand, for it to have best effect, it extends around the discharge opening. In other words, the sieve might surround the discharge opening. Indeed, the sieve might be circular or comprise a ring. The discharge opening can be within the ring, e.g. at its centre. However, it is possible that the discharge opening could be on one side of the surface. In this case, the sieve might only extend around the side of the discharge opening toward the surface. The remainder of the discharge opening might be bounded by a side wall of the filter support or such like:

As described above, the coffee maker typically uses a filter to hold coffee grounds in the brewing chamber. The main purpose of the sieve is therefore to prevent stray coffee grounds that escape from the filter from blocking the discharge opening. The coffee maker may be a pad-type coffee maker. The filter may therefore be a filter pad. Indeed, the invention may include the filter, e.g. the filter pad. The coffee maker may also include a foam chamber for receiving liquid from the discharge opening. Similarly, the coffee maker may include a hot water delivery system. In a pad-type coffee maker, this may deliver hot water to the brewing chamber at around 1 bar over atmospheric pressure (e.g. less than 3 bar and preferably 0.8-1.6 bar).

Filter coffee makers and pad-type coffee makers use disposable filters or filter pads. However, the invention is not limited to coffee makers using disposable filters. Indeed, the applicants have specifically recognized that the sieve can have utility in other coffee machines. For example, the sieve may be used in a coffee grounds holder of an espresso coffee maker. Usually, the base of such a coffee grounds holder incorporates the discharge opening and a perforated metal sheet is provided above the opening to hold coffee grounds in place. This perforated sheet can be thought of as the filter referred to above. The sieve of the invention can be positioned under the perforated sheet, where it prevents coffee grounds blocking the discharge opening, even if they pass through the perforated sheet.

Preferred embodiments of the invention will now be described, by way of example only, with reference to the accompanying drawings, in which:

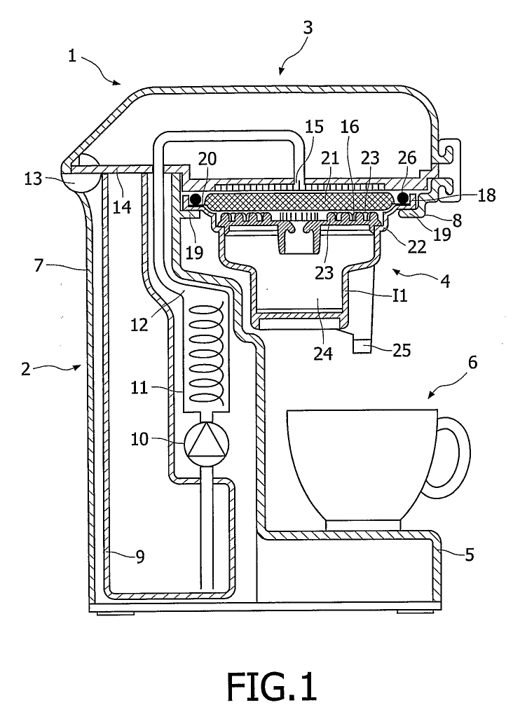

FIG. 1 is a schematic illustration showing sectional side view of a coffee maker according to the invention;

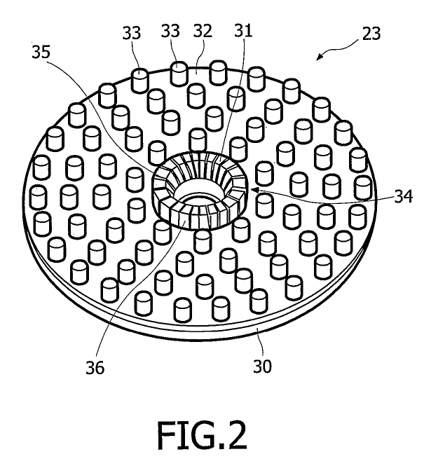

FIG. 2 is a schematic illustration of a first embodiment of a filter support of the coffee maker of FIG. 1;

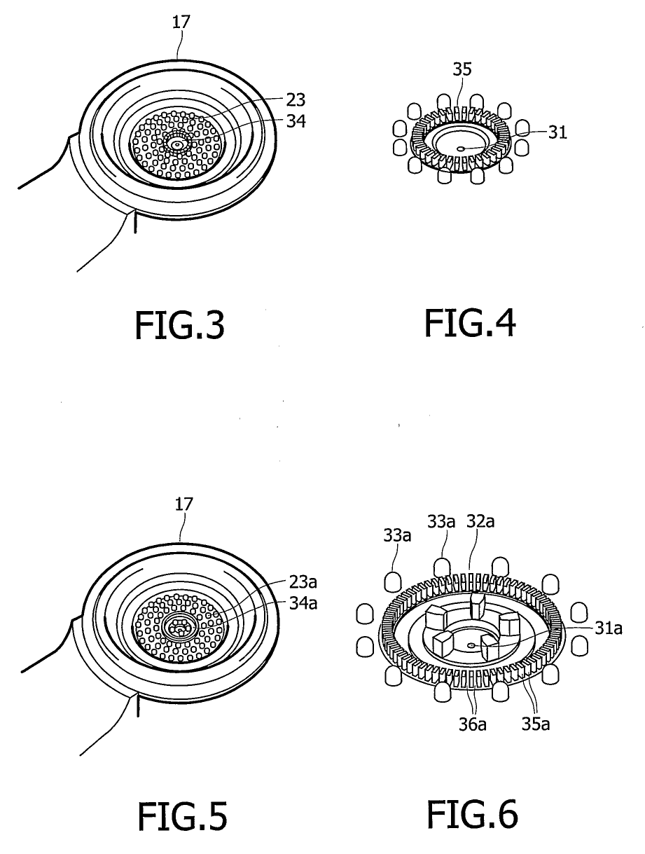

FIG. 3 is an illustration of the filter support of FIG. 2 positioned in a filter assembly of the coffee maker of FIG. 1;

FIG. 4 is an illustration showing a close-up view of a sieve of the filter support of FIGS. 2 and 3;

FIG. 5 is an illustration of a second embodiment of a filter support of the coffee maker of FIG. 1 positioned in a filter assembly;

FIG. 6 is an illustration showing a close-up view of a sieve of the filter support of FIG. 5;

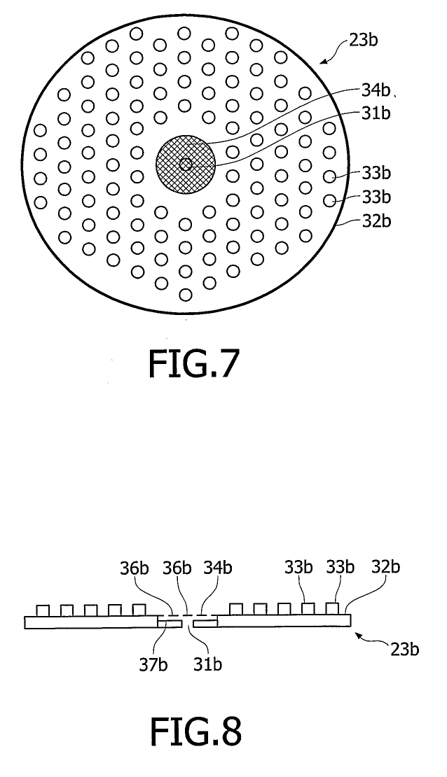

FIG. 7 is a schematic illustration showing a plan view of a third embodiment of a filter support of the coffee maker of FIG. 1;

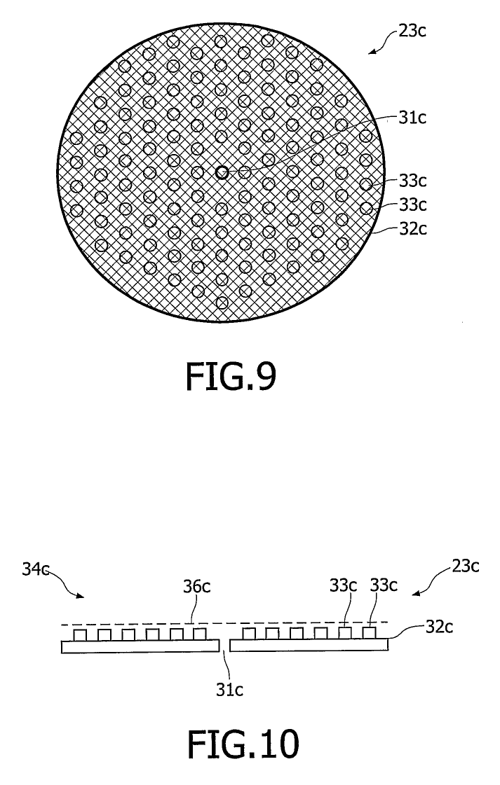

FIG. 8 is a schematic illustration showing a cross-sectional view of the filter support of FIG. 7 along the line A-A FIG. 9 is a schematic illustration showing a plan view of a fourth embodiment of a filter support of the coffee maker of FIG. 1; and

FIG. 10 is a schematic illustration showing a cross-sectional view of the filter support of FIG. 9 along the line B-B.

Referring to FIG. 1, a coffee maker 1 comprises a housing 2 with a lid 3 and a removable filter assembly 4. The housing 2 has a platform 5, on which a cup 6 can be placed, an upright body 7 and a filter assembly support 8 that accommodates the removable filter assembly 4 and supports it in a position over the cup 6 on the platform 5.

The upright body 7 houses a hot water delivery system comprising a water reservoir 9, a water pump 10, a water heater 11 and a conduit 12. In this embodiment, the water reservoir 9 extends over the full height of the upright body 7 and is open at its top so that it can be easily filled with water.

The water pump 10 is connected to draw water from the bottom of the water reservoir 9 and push it through the water heater 11 and, from there, along the conduit 12.

The lid 3 is hinged at the top of the upright body 7 by a hinge 13 and, when it is closed, a bottom surface 14 of the lid 3 closes the opening in the reservoir 9 to prevent water in the reservoir 9 spilling out. The conduit 12 extends into the lid 3 and opens into a recess 15 on the bottom surface of the lid 3. When the lid 3 is closed, the recess 15 is positioned above the filter assembly support 8 and consequently the removable filter assembly 4 when positioned in the support 8. As described in more detail below, together with the filter assembly 4, the recess 15 forms a brewing chamber 16

The filter assembly 4 comprises a cup shaped body 17. A rim 18 running around the outside of an open end of the cup shaped body 17 is arranged to rest on tabs 19 of the filter assembly support 8. In this embodiment, the filter assembly 4 is positioned on and removed from the filter assembly support 8 by the rim 18 of the cup shaped body 17 sliding along the tabs 19 of the filter assembly support 8. In other embodiments, a bayonet fitting or such like is provided. A handle (not shown) extends from the cup shaped body 17 to allow the filter assembly 4 to be manipulated.

The diameter of the cup shaped body 17 is largest at the open end, which is uppermost in use. Inward of open end is a filter ledge 20. The filter ledge 20 is a lip extending around the inside surface of the cup shaped body 17 for supporting the perimeter of a filter pad 21. In this embodiment, the filter pad 21 is a disc of filter paper holding coffee grounds. More specifically, two circular pieces of filter paper sandwich the coffee grounds and are glued, or otherwise joined, together at their perimeter. The filter ledge 20 of the cup shaped body 17 has a slightly smaller diameter than the perimeter of the filter pad 21 so that, when the filter pad 21 is placed inside the cup shaped body 17, its perimeter rests on the filter ledge 20.

Inward of the filter ledge 20 is a support ledge 22. Similar to the filter ledge 20, the support ledge 22 is a lip extending around the inside surface of the cup shaped body 17. However the support ledge 22 is arranged to support a filter support 23. As described in more detail below, the filter support 23 is a disc that, in this embodiment, has a slightly smaller diameter than the filter pad 21. Again similar to the filter ledge 20, the support ledge 22 has a slightly smaller diameter than the perimeter of filter support 23 so that, when the filter support 23 is placed inside the cup shaped body 17, its perimeter rests on the support ledge 22. When in position in the cup shaped body 17, the filter support 23 is below the filter pad 21 and supports the underside of the pad 21. It also forms the base of the brewing chamber 16. More specifically, the brewing chamber 16 is bounded by the recess 15 of the lid 3, the filter support 23 and a side wall of the cup shaped body 17. An o-ring seal 26 is provided around the perimeter of the recess 15 in the lid 3. The seal 26 cooperates with the filter assembly 4 to provide a fluid tight seal around the chamber 16 when the lid is closed 3.

Inward of the support ledge 22, the cup shaped body 17 is closed to form a foam chamber 24. The foam chamber 24 has an outlet (not shown) into a spout 25 that extends from the cup shaped body 17 and from which coffee can be dispensed into the cup 6.

Referring now to FIGS. 2 to 4, in a first embodiment, the filter support 23 comprises a disc with a lip 30 around its perimeter. It is the lip 30 of the filter support 23 that rests on the support ledge 22 of the cup shaped body 17 of the filter assembly 4 when the filter support 23 is positioned for use. In the centre of the support 23 is a discharge opening 31. The discharge opening 31 extends through the plane of the disc so that liquid can pass from one side of the filter support 23 to the other. One side of the filter support 22, which is uppermost in use, has a surface 32 for catching liquid passing out of the filter pad 21 in use. In this embodiment, the surface 32 slopes very slightly toward the discharge opening 31. When the disc is horizontal, as it is intended to be in use, liquid therefore flows across the surface 32 to the discharge opening 26.

On the surface 32 of the filter support 23 there are a plurality of support projections 33. The projections 33 might be referred to as studs, as they are domed and approximately as wide as they are high. Indeed, the projections 33 extend only a few millimetres from the surface 32 of the filter support 23. When the filter pad 21 and filter support 23 are in position, the underside of the filter pad 21 rests on the projections 33. In other words, the projections 33 support the underside of the filter pad 21 away from the surface 32 of the filter support 23. The imaginary surface defined by the ends of the projections 33 distal from the liquid flow surface 32 defines the position of the filter pad 21.

Also on the surface 32 of the filter support 23 is a sieve 34. The sieve 34 extends around the discharge opening 31. In this embodiment, the sieve 34 forms ring around the discharge opening 31. The sieve 34 comprises a plurality of upstands 35 spaced apart to form apertures 36. The purpose of the sieve 34 is to prevent particles, such as stray coffee grounds, reaching and blocking the discharge opening 31. It is therefore desirable for the apertures 36 to be the same width or narrower than the discharge opening 31.

In this embodiment, the discharge opening 31 is around 0.83 mm wide, but can be substantially between 0.75 mm to 0.90 mm wide in other embodiments. Again in this embodiment, the opening 31 is a circular opening and its width is therefore its diameter. Other shapes can be used. The opening 31 may also taper and, in this case, the dimensions given here generally specify the smallest width or diameter.

In order to stop particles that may block the discharge opening 31 from passing, the largest width of the apertures 36 should be less than the smallest width of the opening 31. In this embodiment, the apertures are around 0.5 mm wide. However, the apertures 36 are taller than 0.5 mm from the surface 32. More specifically, the apertures extend to the top of the upstands 35. The upstands 35 are the same height as the projections 33 from the surface 32. The filter pad 21 therefore rests on the upstands 35 and the filter pad 21 therefore effectively closes the sieve 34 at the top of the projections 33.

Referring to FIGS. 5 and 6, in a second embodiment, a filter holder 23a also comprises a disc with a lip (not shown) around its perimeter. A discharge opening 31a is in the same position as that of the first embodiment, i.e. in the centre of the surface 32a, and has the same dimensions. Similarly, the support 23a has a plurality of projections 33a on its surface 32a.

However, in this embodiment, the sieve 34a extends around the discharge opening 31a at a greater distance from the discharge opening 31a than that of the first embodiment. In other words, whilst the upstands 35a and apertures 36a of the sieve 34a may be similar in size and shape to those of the first embodiment, in the second embodiment the sieve 34a forms ring of greater diameter then that of the first embodiment. This means that the projections 33a are positioned adjacent the discharge opening 31a, e.g. inside the ring of the sieve 34a. The larger diameter of the sieve 34a allows it to have more apertures 36a.

Referring to FIGS. 7 and 8, in a third embodiment, a filter holder 23b again comprises a disc with a lip (not shown) around its perimeter. A discharge opening 31b is in the same position as that of the first and second embodiments, i.e. in the centre of the surface 32b, and has the same dimensions. Similarly, the support 23b has a plurality of projections 33b on its surface 32b.

However, in this embodiment, the sieve 34b comprises a mesh extending over the discharge opening 31b. The mesh of the sieve 34b is substantially parallel and in line with the surface 32b. In other words, it is perpendicular to the discharge opening 31b. This is achieved by housing the sieve 34b in a recess 37b adjacent and surrounding the opening 31b. More specifically, the mesh of the sieve is mounted in a frame that fits into the recess and spaces the mesh away from the surface of the recess. This allows liquid to flow through all the apertures 36b of the sieve to the discharge opening 31b. The sieve 34b can be removed for cleaning.

Referring to FIGS. 9 and 10, in a third embodiment, a filter holder 23c again comprises a disc with a lip (not shown) around its perimeter. A discharge opening 31c is in the same position as that of the first, second and third embodiments, i.e. in the centre of the surface 32c, and has the same dimensions. Similarly, the filter holder 23c has a plurality of projections 33c on its surface 32c.

In this embodiment, the sieve 34c comprises a mesh extending over the surface 32c. More specifically, the sieve 34c comprises a mesh resting on the projections 33b of the filter holder 23c. The sieve 34c is the same size and shape as the surface 32c so that all brewed coffee passing out of the filter pad 21 to the surface 32c passes through the sieve 34c. It can be appreciated that, in this embodiment, the filter pad 21 rests on the sieve 34c, which in turn rests on the projections 33c.

To make coffee, a user first fills the water reservoir 9 with water. This is done by opening the lid 3 and pouring water into the top of the reservoir 9. With the lid 3 open, the user also inserts the filter support 23,23a,23b,23c, if it is not already in place, and a filter pad 21 into the removable beverage preparation assembly 4. More specifically, a filter pad 21 is placed on the filter support 23,23a,23b,23c. The lid 3 is then shut.

The water pump 10 pumps water through the water heater 11, where it is heated to a desired temperature, e.g. slightly below boiling point, and through the conduit 12 to the brewing chamber 16. Water passes into the brewing chamber 16 at a pressure of around 1 bar (e.g. 0.8 bar to 1.6 bar) over atmospheric pressure. The water arrives at the top of the filter pad 21 and is pressed through the filter pad 21, where it mixes with the coffee grounds in the filter pad 21 to form brewed coffee. The brewed coffee passes out of the bottom of the filter pad 21 to the surface filter support 23,23a,23b,23c.

In the first, second and third embodiments, the surface 32,32a,32b of the filter support 23,23a,23b catches the brewed coffee and directs it toward the nozzle 31,31a,31b. As the brewed coffee passes over the surface 32,32a,32b it encounters the sieve 34,34a,34b. More specifically, it flows through the apertures 36,36a,36b of the sieve 34,34a,34b. If the filter pad 21 is torn and/or there are any stray coffee grounds or particles in the chamber 16 that are larger than the apertures 36,36a,36b, these are stopped by the sieve 35,35a,35b.

In the third embodiment, the brewed coffee first flows through the apertures 36c of the sieve 34c and any stray coffee grounds or particles in the chamber 16 that are larger than the apertures 36c are stopped by the sieve 35c straightaway. The brewed coffee is then caught by the surface 32c, which directs it toward the nozzle 31c.

In all the embodiments, the brewed coffee then flows though the nozzle 31,31a,31b,31c to the foam chamber 24. The brewed coffee enters the foam compartment chamber 24 as a jet of liquid. As it the jet impacts the bottom of the foam chamber 24, foam is created. Furthermore, the spout 25 is small enough that coffee exits the chamber 24 more slowly than it enters the chamber 24 through the nozzle 31,31a,31b,31c. The foam chamber 24 therefore acts as a buffer temporarily storing some of the coffee. The jet of liquid can interact with the stored coffee and this improves foam creation. As the coffee leaves the foam chamber 24 through the spout 25, it passes along the spout 25 and is dispensed into the cup 6 for drinking.

The described embodiments of the invention are only embodiments of how the invention may be implemented. Modifications, variations and changes to the described embodiments will occur to those having appropriate skills and knowledge. These modifications, variations and changes may be made without departure from the spirit and scope of the invention defined in the claims and its equivalents.

For example, whilst the invention has been described above only in relation to making coffee, it is also applicable to coffee makers that are able to make other beverages, such as tea and hot chocolate. These might be commercial or domestic beverage makers or even vending machines.

1. A coffee maker having a brewing chamber and a filter support for supporting a filter in the brewing chamber at a defined position, the filter support comprising: a discharge opening for discharging brewed coffee from the brewing chamber and a sieve between the defined position and the discharge opening the sieve having apertures that allow brewed coffee to pass, but that are the same width or narrower than the discharge opening.

2. The coffee maker claim 1, wherein the apertures are around 0.5 mm wide.

3. The coffee maker claim 1, wherein the filter support further comprises a surface for directing brewed coffee to the discharge opening.

4. The coffee maker of claim 3, wherein the filter support comprises one or more projections for spacing the filter 21 away from the surface.

5. The coffee maker of claim 3, wherein the sieve extends over the surface.

6. The coffee maker of claim 5, wherein the sieve is supported by the projections in use.

7. The coffee maker of claim 3, wherein the sieve comprises an upstand on the surface and extends around the discharge opening.

8. The coffee maker of claim 1, wherein the sieve is open at the defined position of the filter.

9. The coffee maker of claim 1, wherein the sieve comprises a plurality of upstands on the surface which upstands are spaced apart so that the spaces between the upstands provide the apertures.

10. The coffee maker of anyone of claim 1, wherein the sieve extends across the discharge opening.

11. The coffee maker of anyone of claim 1, wherein the sieve is a mesh.

12. The coffee maker of anyone of claim 1 arranged as a pad-type coffee maker.

13. The coffee maker of claim 1, wherein the discharge opening is between 0.75 mm and 0.9 mm wide.

14. The coffee maker of claim 1, further comprising a filter (21) supported in the brewing chamber by the filter support.

15. A filter support for supporting a filter in a brewing chamber of a coffee maker at a defined position, the filter support comprising:
a discharge opening for discharging brewed coffee from the brewing chamber and a sieve between the defined position and the discharge opening the sieve having apertures that allow brewed coffee to pass, but that are the same width or narrower than the discharge opening.

16. The filter support of claim 15, comprising a single injection moulded piece.

17. A method of manufacturing a filter support according to claim 15, the method comprising injection moulding the filter support as a single piece.
